(19) United States
(12) Patent Application Publication
(10) Pub. No.: US 2015/0165252 A1
(43) Pub. Date: Jun. 18, 2015

(54) VISUAL ASSEMBLY AID FOR SPRINKLER AND METHOD FOR USE

(71) Applicant: The Reliable Automatic Sprinkler Co., Inc., Liberty, SC (US)

(72) Inventors: Wayne Koppe, Liberty, SC (US); Oliver Pahila, Liberty, SC (US)

(21) Appl. No.: 14/404,443

(22) PCT Filed: May 30, 2013
(86) PCT No.: PCT/US13/43362

§ 371 Date: Nov. 26, 2014

Related U.S. Application Data
(60) Provisional application No. 61/653,293, filed on May 30, 2012.

(51) Int. Cl. A62C 37/08; A62C 37/50

(52) U.S. Cl. CPC A62C 37/08; A62C 37/50

(57) ABSTRACT

A fire protection sprinkler includes a body having an input end and an output end, the body having an output orifice at the output end. The sprinkler includes a frame extending from the body in the output direction and a deflector supported by the frame positioned opposite the output orifice. Also, the sprinkler includes a seal assembly which seals the output orifice. The seal assembly has a first side and a second side, the first side bearing identifying indicia associated with the orientation of the seal assembly. When the first side is oriented in the input direction, a portion of the indicia is visible from the input end, to indicate a correct assembly. However, when the first side is oriented in the output direction, none of the indicia is visible from the input end, indicating incorrect assembly. The identifying indicia can take the form of one or more of the following: a color, a character, a symbol, and a mark. The seal assembly can include a cap and an annular spring washer, such as a Belleville spring washer, used to provide a pressure seal.

This application claims benefit under 35 U.S.C. §119(e) of provisional A. No. 61/653,293, filed May 30, 2012, the entire contents of which are incorporated herein by reference.

### BACKGROUND OF THE INVENTION

1. Field of the Invention

This application relates to assembly aids for assembly fire protection sprinklers, and more particularly, to visual aids to assist in accurate assembly.

2. Background

Some conventional sprinklers include relatively small parts that are assembled by hand. Also, some sprinklers include parts which, after assembly, are fully or partially concealed during visual inspection. Moreover, certain parts, such as seals, may have a required directional orientation which is not visually verifiable when the sprinkler is fully assembled, that is, the orientation of the part in the sprinkler is difficult to determine, so that it is hard to determine if the seal is properly oriented in the sprinkler assembly.

### SUMMARY

Thus, it would beneficial to have a visual aid that would indicate that certain parts of the sprinkler were properly assembled.

To provide such a visual aid, a fire protection sprinkler is described that includes a body having an input end and an output end, the body having an output orifice at the output end. The sprinkler includes a frame extending from the body in the output direction and a deflector supported by the frame positioned opposite the output orifice. Also, the sprinkler includes a seal assembly which seals the output orifice. The seal assembly has a first side and a second side, the first side bearing identifying indicia associated with the orientation of the seal assembly. When the first side is oriented in the input direction, a portion of the indicia is viewable from the input end to indicate a correct assembly. However, when the first side is oriented in the output direction the indicia are not viewable from the input end to indicate an incorrect assembly.

The identifying indicia can take the form of at least one of the following: a color, a character, a symbol, and a mark. The seal assembly can include a cap and an annular spring washer, such as a Belleville spring washer.

### BRIEF DESCRIPTION OF THE DRAWINGS

FIG. 1 shows an embodiment of a fire protection sprinkler in accordance with an aspect of the invention.

FIG. 2A shows a view of an embodiment of an annular spring washer in accordance with an aspect of the invention, viewed from an upper side of the washer.

FIG. 2B shows a view of a conventional annular spring washer viewed from an upper side.

FIG. 3A shows the annular spring washer of FIG. 2A viewed from a lower side of the washer.

FIG. 3B shows the annular spring washer of FIG. 2B viewed from a lower side of the washer.

FIG. 4A shows a view of the sprinkler shown in FIG. 1A viewed from a lower end of the sprinkler when constructed with the washer shown in FIGS. 2A and 3A.

FIG. 4B shows a view of the sprinkler shown in FIG. 1A viewed from a lower end of the sprinkler when constructed with the washer shown in FIGS. 2A and 3A.

FIG. 5A shows an embodiment of a fire protection sprinkler in accordance with an aspect of the invention.

FIG. 5B shows a plan view of the sprinkler of FIG. 5A viewed from above the sprinkler.

### DETAILED DESCRIPTION

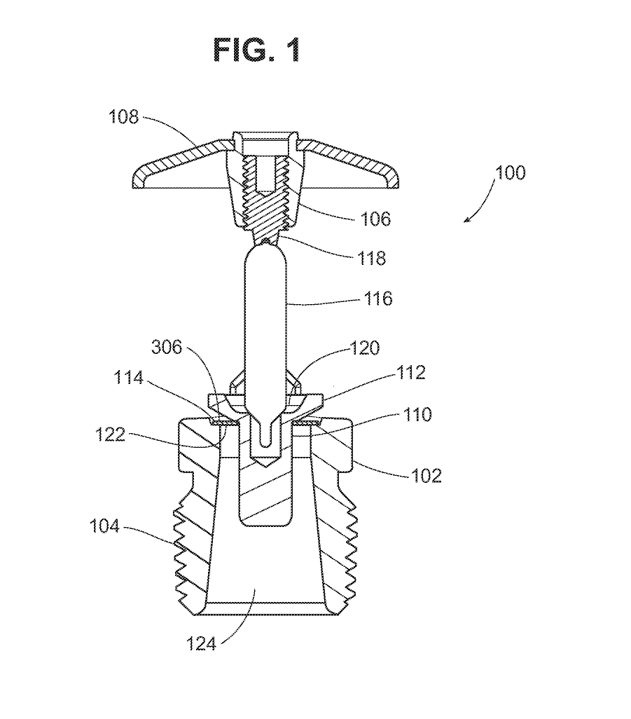

FIG. 1 shows a section through a fire sprinkler 100. The sprinkler 100 includes a body 102 having a threaded base 104 and a pair of frame arms (not shown) extending from the base towards a hub 106. The sprinkler 100 also includes a deflector 108 attached to the frame arms at the hub 106. The hub 106 and deflector 108 are positioned longitudinally opposite an output orifice 110 formed through the body 102 of the sprinkler 100. The sprinkler 100 also includes a cup 112 and an annular spring washer 114 which is positioned between the cup 112 and the body 102 of the sprinkler 100.

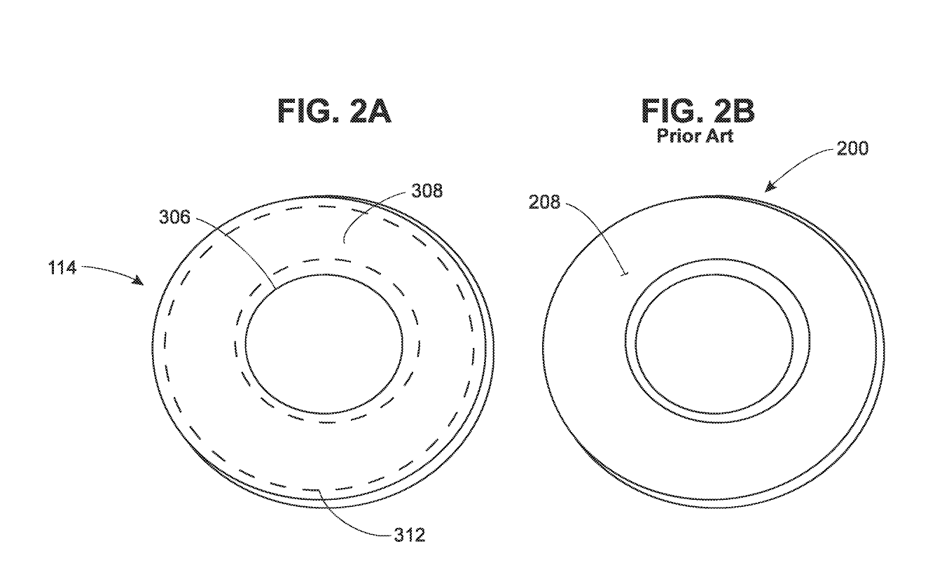

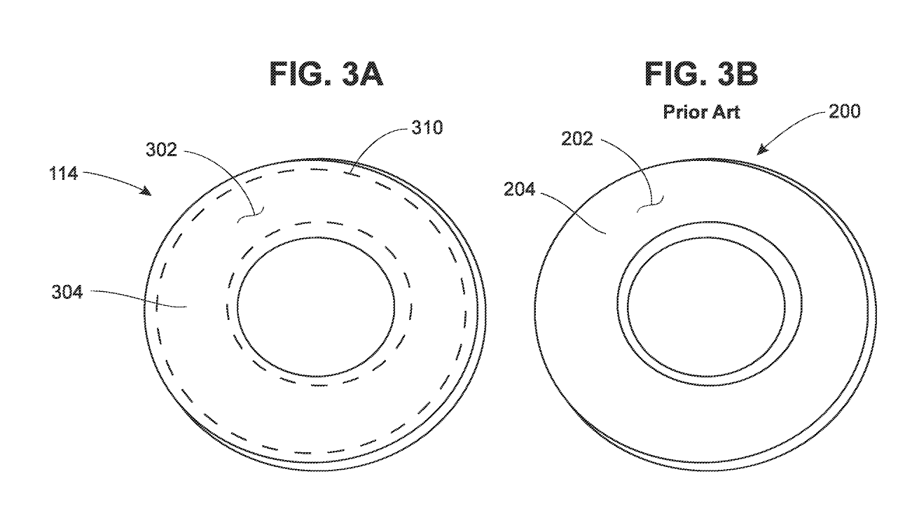

A conventional Belleville spring washer 200 is shown in FIGS. 2B and 3B in its uncompressed state. As shown in FIGS. 2B and 3B the conventional Belleville spring washer 200 has a generally frustoconical form. The annular spring washer 114 employed in accordance with an embodiment of the invention adopts such a conventional Belleville spring shape, as shown in FIGS. 2A and 3A. The conventional washer 200 shown in FIGS. 2B and 3B has the same color on its upper side 208 and lower side 204. However, the lower side 304 of the annular spring washer 114 shown in FIG. 3A is colored a different color than the upper side 308 of the annular spring washer 114 shown in FIG. 2A. When compressed, the washers 114 and 200 shown in FIGS. 2A, 2B, 3A and 3B are constructed to assume a flattened shape, as shown in FIG. 1.

Also, the Belleville spring washer 200 typically has a layer of a material 202 (FIG. 3B), such as polytetrafluoroethylene, applied to the lower, wetted side 204 of the washer 200. The layer of material 202 forms a suitable seal between the washer 200 and the cup (e.g. 112) and the body (e.g. 102) of the sprinkler (e.g. 100) when the Belleville spring washer 200 is compressed. Typically, the layered material 202 has a clear or transparent appearance, so that when viewed the color of the underlying washer 200 is visible through the layer 202, and thus, the upper and lower sides, 208 and 204, respectively, of the washer 200 appear to have the same color.

However, in accordance with one embodiment, at least one layer of material 302 (FIG. 3A) is applied to the lower, wetted side 304 of the annular spring washer 114 so that when the layered washer 114 is viewed, the two sides 304 and 308 of the washer 114 are colored differently. The material 302 can be applied as a tape, film, or a coating, such as a liquid or powder coating.

As shown in FIG. 1, a thermally responsive glass bulb 116 is retained between a load screw 118 threaded in the hub 106 and a cavity 120 in the cup 112. The load screw 118 is tightened against the glass bulb 116 so as to apply a compressive load to the glass bulb 116 which transfers the load to the cup 112, which compresses the annular spring washer 114 into a generally flat orientation against an annular sealing surface 122 formed in the body 102 around the output orifice 110. When so assembled, the cup 112 and the annular spring washer 114 seal the output orifice 110 closed.

As shown in FIGS. 2A and 3A, the annular spring washer 114, in its uncompressed state, has a frustoconical appearance. The spring washer 114 is constructed to be positioned in the sprinkler 100 with a tapered end 306 in the output direction facing the hub 106. However, it is possible to orient and assemble the spring washer 114 incorrectly, with the tapered end 306 oriented in the input direction facing the body 102. Whether the spring washer 114 is oriented in the desired direction described above, or not, the spring washer 114 takes a generally planar appearance, even upon close visual inspection from an open end 124 of the body 102. Therefore, those of ordinary skill in the art will appreciate that it is difficult to see, after assembly of the sprinkler 100, whether the spring washer 114 is oriented as desired. Moreover, when the annular spring washer 114 is incorrectly oriented and the sprinkler 100 has been completely assembled, there is a possibility that the sprinkler 100 may pass visual inspection and hydrostatic pressure testing, but fail, such as by leaking, when installed in a sprinkler system.

In accordance with an aspect of the invention, the annular spring washer 114 bears indicia, which can be visually observed both before and after assembly of the sprinkler 100 and which indicate the orientation of the washer 114 in the assembled sprinkler 100. In one embodiment, the sprinkler 100 includes an annular spring washer 114 that has a first, wetted side 304 (FIG. 3A) that has a portion that is visible after assembly of the sprinkler 100 and which has predetermined identifying indicia 302 that is/are unique to the wetted side 304. The second side 308 (FIG. 2A) of the washer 114, the non-wetted side, has a portion of its surface directly opposite that of the first side 304 which does not bear such indicia 302. Accordingly, the indicia 302 associated with the wetted side 304 of the washer 114 can only be viewed when the washer 114 is oriented with the wetted side 304 visible from the open end 124 of the body 102, which is the desired orientation.

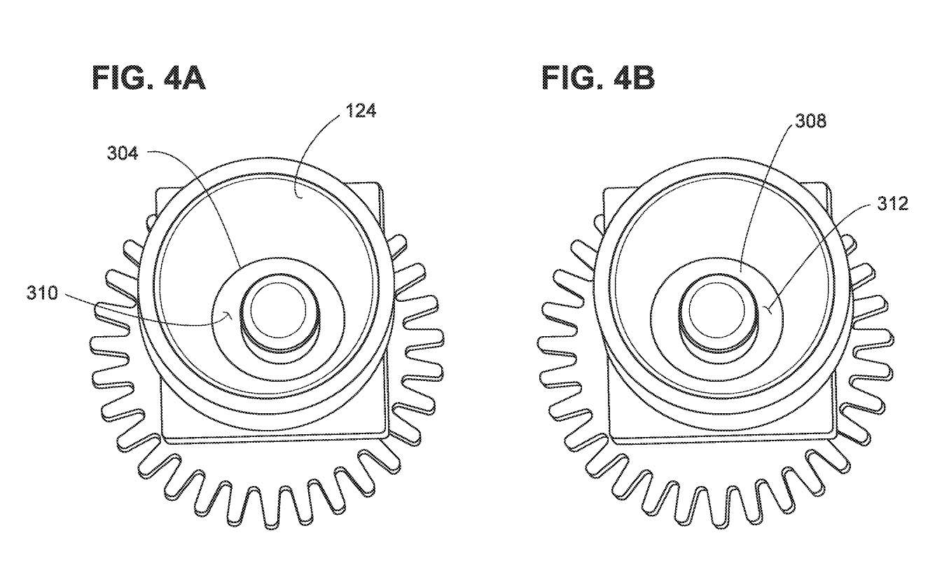

The identifying indicia 302 include at least one of a color, character, pattern, mark, logo, picture, or other visual identifier. For example, in one embodiment the wetted side 304 has a region 310 (FIG. 3A) which includes a predetermined color identifying the wetted side 304. The colored region 310 is visible from the open end 124 of the sprinkler body 102, as shown in FIG. 4A. A corresponding region 312 on the un-wetted side 308 does not include the color. Thus, if the sprinkler 100 is visually inspected, if the colorized portion 310 of the wetted side 304 can be seen, as shown in FIG. 4A, a determination can be quickly made that the washer 114 is oriented properly. On the contrary, if the non-colored side 308 is visible from the open end 124 of the sprinkler body 100, as shown in FIG. 4B, a determination can be quickly made that the washer 114 is oriented opposite the desired orientation and that the assembly is defective.

In one embodiment, the wetted side 304 of the annular spring washer 114 is layered with a polytetrafluoroethylene tape 302 that is colorized, such as with a blue color, and at least a portion of the tape 302 is applied in a region 310 of the wetted side 304 such that the color is visible from an open end 124 of the body 102 of the sprinkler 100 when the washer 114 is in its assembled state. Of course, as described above, the colored layer can also be formed as a film, or a coating, including a powder or liquid coating.

In another embodiment (not shown), the wetted side 304 of the annular spring washer 114 bears a character string such as “OK” that is positioned in the viewable region 310 of the wetted side 304 of the washer 114 when the washer 114 is assembled.

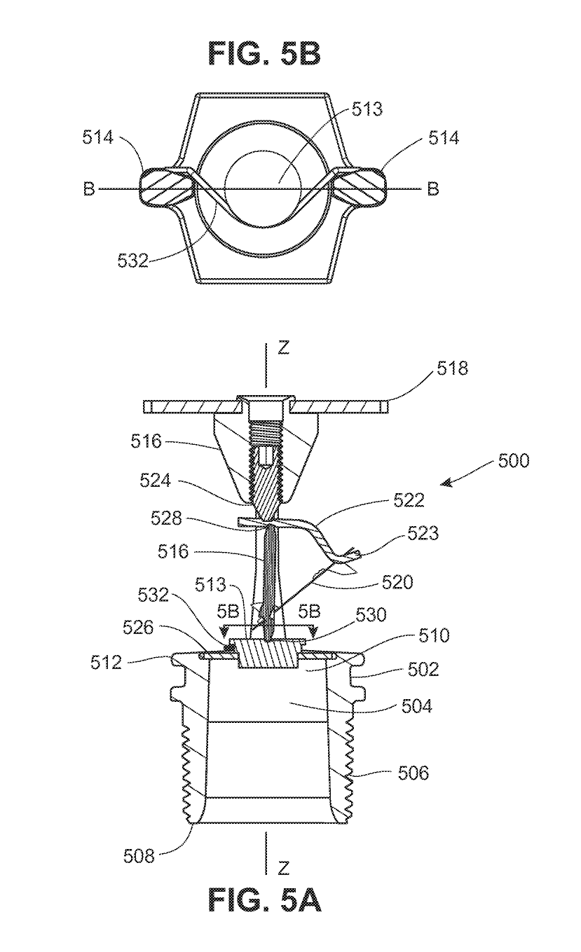

FIG. 5A shows a section of another embodiment of a sprinkler 500 that can be used in accordance with the present invention. The sprinkler 500 is shown upside down in FIG. 5A. The sprinkler 500 has a body 502 defining an axial fluid passage 504 and which may have the features of a model JL17 sprinkler, manufactured by the Reliable Automatic Sprinkler Company, Inc., of Liberty, S.C. The body 502 has a threaded portion 506 on its outer surface to allow the sprinkler 500 to be connected to a conduit (not shown) for providing pressurized fire-extinguishing fluid, such as water, to an input end 508 of the fluid passage 504. The fluid passage 504 has an output orifice 510 at an opposite end 512 that is sealed by a seal cap 513. The input end 508 may have a nominal diameter of, for example, 1 inch NPT (national pipe thread). The sprinkler 500 may have a K-factor of, for example, 17, which is defined by K=Q/√(p), where Q is the flow rate in gallons per minute and p is the residual pressure at the input end 508 of the sprinkler 500 in pounds per square inch.

Two frame arms 514 (seen in section in FIG. 5B) extend from the body 502 and meet at a hub 516 positioned below and in axial alignment with the output orifice 510 (since the sprinkler 500 is shown upside down in FIG. 5A, the frame arm 514 visible behind strut 516 actually extends upward in that drawing). A deflector 518 is positioned on the hub 516 so as to be impinged by the output fluid upon activation of the sprinkler 500. As further discussed below, the deflector 518 in this particular embodiment is a circular, planar disk that is centered on and orthogonal to an axis Z-Z of the fluid passage. The disk 518 may have a number of slots of varying length and orientation arrayed around its periphery.

A release mechanism 520, e.g., a fusible link assembly, having a thermally-responsive element, e.g., a fusible link, is positioned between the hub 516 and the seal cap 513 to hold the seal cap 513 in place over the output orifice 510. As shown in the sectional view of FIG. 5A, the link assembly 520 includes a lever 522 positioned on a set screw 524 that extends upward from the hub 516. Strut 516 is positioned between the seal cap 513 and the lever 522, such that one end of the strut 516 is positioned in a slot 524 on the surface of the seal cap 510 and the other end is positioned in a slot 528 on the lever 522, slightly offset from the set screw 524.

The pressure of the fluid on the seal cap 510 causes a downward force on the strut 516, which in turn causes an extended end 523 of the lever 522 to tend to rotate away from the strut 516 (i.e., the lever 522 rotates counter-clockwise in the view of FIG. 5A). The rotational force on the lever 522 creates a tension force on the fusible link 520, which is attached between the extended end 523 of the lever 522 and a hook (not shown) on the upper portion of the strut 516.

The fusible link 520 comprises two thin, metal plates, e.g., beryllium-nickel alloy, one plate connected to the lever 522 and the other plate connected to the strut 516. The plates are joined in an overlapping manner with solder that melts at a predetermined temperature. The link 520 separates at the predetermined temperature, due to the tension force applied by the lever 522 and the strut 516, allowing the lever 522 and the strut 516 to swing outward. This in turn releases the seal cap 513 and allows the fluid to be output from the orifice 510.

Positioned between annular spring washer 526 and an annular flange 530 of the cap 513 is a trip spring 532. As shown in greater detail in FIG. 5B, the trip spring 532 is in contact with a portion of the circumferential surface of the cap 513 between the flange 530 of the cap 513 and the spring washer 526, below the plane B-B passing through the frame arms 514. The trip spring 532 extends to the frame arms 514 on an upper side of plane B-B. Thus, the trip spring 532 is resiliently retained between the frame arms 514 to bias the cap 513 in an upward direction in FIG. 5B so that when the cap 513 is released during sprinkler activation the cap 513 will be jettisoned outwardly away from sprinkler axis Z-Z.

The annular spring 526 washer in FIG. 5A can be formed with one or more indicia as described above in connection with the embodiments shown in FIGS. 1, 2A, 3A, and 4A. For example, in one embodiment one layer of a colored material, such as material 310, may be formed on one side of the washer 526 in FIG. 5A which results in both sides of the washer 526 being colored differently.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

What is claimed is:

1. A fire protection sprinkler comprising:
a body having an input end and an output end, the body having an output orifice at the output end; and
a seal assembly which seals the output orifice, wherein the seal assembly has a first side and a second side, the first side bearing identifying indicia associated with the orientation of the seal assembly, wherein when the first side is oriented in the input direction a portion of the indicia is viewable from the input end to indicate a correct assembly and wherein when the first side is oriented in the output direction the indicia is not viewable from the input end to indicate an incorrect assembly.

2. The fire protection sprinkler according to claim 1, wherein the indicia includes at least one of a color, a character, a symbol, and a mark.

3. The fire protection sprinkler according to claim 2, wherein the seal assembly includes a seal cap and an annular seal washer.

4. The fire protection sprinkler according to claim 3, wherein the seal washer is a Belleville spring washer.

5. The fire protection sprinkler according to claim 3, wherein the annular spring washer bears at least a portion of the indicia.

6. The fire protection sprinkler according to claim 5, wherein the annular spring washer includes a layer bearing the indicia.

7. The fire protection sprinkler according to claim 6, wherein the layer is formed from polytetrafluoroethylene.

8. The fire protection sprinkler according to claim 6, wherein the annular spring washer includes at least one colorized applied layer on at least one of its two sides, wherein the colors on each of the two sides are different.

9. A method of manufacturing a sprinkler comprised of a body having an input end and an output end, the body having an output orifice at the output end,
providing a seal assembly for sealing the output orifice, the seal assembly having
a first side and a second side, the first side bearing identifying indicia associated with the orientation of the seal assembly

10. The method according to claim 9, further comprising orienting the seal assembly with the first side in the input direction and positioning the seal assembly on the body at the output orifice, and sealing the output orifice.

11. The method according to claim 10, wherein the method further includes viewing the seal assembly from the input end of the body, and verifying the orientation of the seal assembly, wherein when the first side is oriented in the input direction a portion of the indicia is viewable from the input end to indicate a correct assembly and wherein when the first side is oriented in the output direction the indicia is not viewable from the input end to indicate an incorrect assembly.
